(19) United States
(12) Patent Application Publication
(10) Pub. No.: US 2015/0065398 A1
(43) Pub. Date: Mar. 5, 2015

(54) NANOPARTICLE LUBRICITY AND ANTI-CORROSION AGENT

(71) Applicant: KMP Holdings, LLC, Wichita, KS (US)

(72) Inventors: Cherie Gartland, Youngsville, LA (US); Guy McClung, Spring, TX (US); Randy Block, Lafayette, LA (US)

(21) Appl. No.: 14/475,265

(22) Filed: Sep. 2, 2014

Related U.S. Application Data
(60) Provisional application No. 61/872,323, filed on Aug. 30, 2013.

(51) Int. Cl. C09K 8/36

(52) U.S. Cl. CPC C09K 8/36; C09K 2208/32; C09K 2208/34; C09K 2208/28
USPC 507/118; 507/136

(57) ABSTRACT

The invention provides, inter alia, compositions and methods of using a lubricating agent containing nanoparticles in various drilling applications. Furthermore, the lubricating agent may act as a corrosion inhibitor and a friction reducer.

### CROSS-REFERENCE TO RELATED APPLICATIONS

This application claims the benefit of U.S. Provisional Application No. 61/872,323 filed Aug. 30, 2013 which is expressly incorporated herein by reference in its entirety for all purposes.

### BACKGROUND OF THE INVENTION

Subterranean drilling pipe lubricants are used in drilling operations to minimize friction between metal surfaces, such as pipes (e.g., casing, drill string and coil tubing) and wellbores. Typically these lubricants are formulated to chemically and mechanically lubricate. For example, several commercially available lubricants contain micron-sized polymer (e.g., styrene) or glass beads to provide mechanical lubrication. The polymer beads range from 425-850 μm in size while the glass beads are slightly smaller at about 180-355 μm.

However, due to their size, the micron beads can block the pipe or wellbore during drilling and prevent fluid flow. There is a need for improved lubricants that do not cause clogging of drill pipes. There is also a need for inhibiting corrosion of metal components of a wellbore, such as the casing and coil tubing. The present invention addresses these and other needs in the art.

### BRIEF SUMMARY OF THE INVENTION

Provided herein, inter alia, are compositions and methods for lubricating a metal and/or inhibiting corrosion of a method using a nanoparticle lubricity and anti-corrosion agent, such as an emulsion. Thus, in some embodiments, the invention provides chemical formulations of the emulsion comprising a hydrophilic polymer, a vegetable oil, a plurality of nanoparticles; and a surfactant.

In some embodiments, the emulsion further includes a fluoropolymer. The fluoropolymer may be polytetrafluoroethylene (PTFE). Optionally, the emulsion further includes an emulsion stabilizing agent. The emulsion stabilizing agent may be a fumed silica emulsion stabilizing agent. In some embodiments, the emulsion further comprises a thickening agent. The thickening agent may be a clay-based thickening agent. In other embodiments, the thickening agent is a clay-based thickening agent, a modified amine or hydrogenated castor oil.

In some embodiments, the emulsion has a density of about 0.92 kg/m³ to about 0.970 kg/m³. The emulsion may also have a density of about 0.94 kg/m³ to about 0.960 kg/m³. Optionally, the emulsion has a density of about 0.948 kg/m³.

In some embodiments, the emulsion has a specific gravity of about 6.0 g/l to about 10.0 g/l at 25° C. The emulsion may also have a specific gravity of about 7.0 g/l to about 9.0 g/l at 25° C. Optionally, the emulsion has a specific gravity of about 7.9 g/l at 25° C.

In some embodiments, the surfactant is a nonionic oil soluble surfactant. The surfactant may also be glycerol mono oleate. In some embodiments, the surfactant provides a hydrophilic lipophilic balance (HLB) of approximately 7, (e.g., about 7).

In some embodiments, the vegetable oil is canola oil, coconut oil, cottonseed oil, olive oil, palm oil, peanut oil, rapeseed oil, safflower oil, sesame oil, soybean oil, sunflower oil, rice bran oil, corn oil, hemp oil, castor oil, almond oil, arachis oil, maize oil, linseed oil, caraway oil, rosemary oil, peppermint oil, eucalyptus oil, coriander oil, lavender oil, citronella oil, juniper oil, lemon oil, orange oil, clary sage oil, nutmeg oil and tea tree oil. Optionally, the vegetable oil is canola oil.

In some embodiments, the hydrophilic polymer is a polyalkylene oxide (e.g. ethoxide, propoxide, etc.) polymer. In some embodiments, the polyalkylene oxide comprises from 1 to 500 alkylene oxide units, e.g., from 1-50, 50-150, 150-250, 250-350, 350-450, 450-500, 1, 10, 20, 30, 40, 50, 60, 70, 80, 90, 100, 120, 125, 130, 140, 150, 160, 170, 175, 200, 225, 250, 275, 300, 325, 350, 375, 400, 425, 450, 475, or 500 alkylene oxide units. The hydrophilic polymer may be a polyethylene glycol.

In some embodiments, the nanoparticle has a density of more than about 2 g/cm³. The nanoparticle may also have a density of more than about 2.5 g/cm³. Optionally, the nanoparticle has a density of more than about 3 g/cm³.

In some embodiments, the nanoparticule is an inorganic nanoparticle. The inorganic nanoparticle may also be a metal nanoparticle. Optionally, the metal nanoparticle is a gold nanoparticle, zirconium nanoparticle, silver nanoparticle, platinum nanoparticle, cerium nanoparticle, or arsenic nanoparticle. In particular instances, the metal nanoparticle is a metal oxide nanoparticle.

In some embodiments, the nanoparticle is an organic nanoparticle. The organic nanoparticle may be a polymeric nanoparticle. The organic nanoparticle may also be a diamond nanoparticle.

In some embodiments, the plurality of nanoparticles is about 2 to about 200 nm in average length. Optionally, the plurality of nanoparticles is about 2 to about 100 nm in average length. The plurality of nanoparticles may also be about 2 to about 50 nm in average length.

In some embodiments, more than 5% of the plurality of nanoparticles are less than 100 nm in length. More than 25% of the plurality of nanoparticles may be less than 100 nm in length. More than 50% of the plurality of nanoparticles may also be less than 100 nm in length. Optionally, more than 75% of the plurality of nanoparticles are less than 100 nm in length.

Also provided is a subterranean pipe including the emulsion described herein. In some embodiments, the subterranean pipe is in fluid contact with a petroleum reservoir. Optionally, the subterranean pipe further include a petroleum. The subterranean pipe may be a metal subterranean pipe.

Also provided is a subterranean drill including the emulsion described herein.

The invention further provides methods of lubricating a metal including contacting the metal with the emulsion described herein. In some embodiments, the emulsion further provides corrosion resistance to the metal. The metal may form part of a drill. In some instances, the drill is a subterranean drill. Optionally, the metal forms part of a pipe. The pipe may be a subterranean pipe (e.g., casing). The subterranean pipe may also be a metal pipe. In some instances, the subterranean pipe is in fluid contact with a petroleum reservoir.

In some embodiments, the invention provides methods of inhibiting corrosion of a metal including contacting the metal with the emulsion described herein. The metal may form part of a pipe. The metal may also form part of a subterranean pipe (e.g., casing). In some instance, the subterranean pipe is in fluid contact with a petroleum reservoir. Optionally, the metal forms part of a drill. The drill may also be a subterranean drill.

Other objects, features, and advantages of the present invention will be apparent to one of skill in the art from the following detailed description and figures.

### DETAILED DESCRIPTION OF THE INVENTION

### I. Introduction

Provided herein are compositions of a lubricating agent and methods of using said lubricating agent for various drilling procedures. The inventors have developed a nanoparticle containing formulation that decreases the friction coefficient by 400% compared to currently available pipe lubricant. Furthermore, the lubricity agent is formulated from Generally Regarded to be Safe (GRAS) materials and acts as a metal corrosion inhibitor.

### II. Definitions

As used herein, the following terms have the meanings ascribed to them unless specified otherwise.

The term “emulsion” refers to a dispersion of one immiscible liquid into another. For example, in a water-in-oil emulsion, the water forms the dispersed (e.g., discontinuous) phase, and the oil is the dispersion (e.g., continuous) medium.

The term “fluoropolymer” refers to any polymer containing a fluoro-substituted hydrocarbon (e.g., organofluorine compound containing carbon and fluorine). Typically, the polymer has multiple carbon-fluorine bonds.

The term “polytetrafluoroethylene” or “PTFE” refers to any polymer of tetrafluoroethylene including the repeating unit (C₂F₄)ₙ where n is typically an integer from 2 to 1000.

The term “nonionic surfactant” is a surfactant (e.g., a chemical that can reduce the surface tension of a liquid) with a non-charged hydrophilic portion. Typically, a surfactant is a chemical that is partly hydrophobic (e.g., lipophilic) and partly hydrophilic. Non-limiting examples of a nonionic surfactant include

The term “nonionic oil soluble surfactant” refers to any nonionic surfactant that is soluble (e.g., miscible) in oil.

The term “hydrophilic lipophilic balance” or “HLB” refers to a scaling system for indicating the solubility property of a nonionic surfactant as known in the art. It can be used as a measure of the degree of hydrophilicity and/or lipophilicity of a surfactant. For example, a lower HLB value represents a more oil soluble (e.g., lipophilic) surfactant. A higher HLB value represents a more water soluble (e.g., hydrophilic) surfactant.

The term “polyalkylene oxide” refers to any polymer with repeating units of a hydrocarbon oxide (i.e., an alkylene oxide unit such as ethylene oxide, propylene oxide, etc.). Polyalkylene oxides can be linear, branched, blocked or random soluble polymers and/or copolymers derived from monomers that are vicinal cyclic oxides, or epoxides of aliphatic olefins, such as ethylene, propylene and butylene.

The term “alkylene oxide unit” is a monomer of a vicinal hydrocarbon oxide, or an epoxide of an aliphatic olefin, such as ethylene, propylene and butylene. Thus, an alkylene oxide unit can be an ethylene oxide having the chemical formulat —C₂H₄O—.

The term “nanoparticle” is a particle having a longest dimension of less than 1 μm in length and are composed of an appropriate material to increase lubricating properties of the agent described herein. In embodiments, the nanoparticle is composed of a rigid material (i.e., a rigid nanoparticle). The nanoparticles used herein may be substantially monodispersed. For example, about 50%, 60%, 70%, 80%, 90%. 95% or 99% of the nanoparticles composed of the same materials have a longest dimension range of ¼ to 4 times or ½ to 2 times the average longest dimension of the nanoparticles. About 50%, 60%, 70%, 80%, 90%. 95% or 99% of the nanoparticles composed of the same materials can have a longest dimension range of ¼ to 4 times the average longest dimension of the nanoparticles. About 50%, 60%, 70%, 80%, 90%. 95% or 99% of the nanoparticles composed of the same materials can have a longest dimension range of ½ to 2 times the average longest dimension of the nanoparticles. In some embodiments, the about 50%, 60%, 70%, 80%, 90%. 95% or 99% of the nanoparticles composed of the same materials have a longest dimension about ±95%, 90%, 80%, 70%, 50%, 40%, 30%, 20% or 10% the average longest dimension of the nanoparticles. In some embodiments, the about 50%, 60%, 70%, 80%, 90%. 95% or 99% of the nanoparticles composed of the same materials have a longest dimension about ±95%, 90%, 85%, 80%, 75%, 70%, 65%, 60%, 55% or 50% the average longest dimension of the nanoparticles. In some embodiments, the about 50%, 60%, 70%, 80%, 90%. 95% or 99% of the nanoparticles composed of the same materials have a longest dimension about ±50%, 45%, 40%, 35%, 30%, 25%, 20%, 15% or 10% the average longest dimension of the nanoparticles. The particle may have a longest dimension of more than 1 nm in length.

The term “polymeric nanoparticle” refers to a nanoparticle composed of polymer compound (e.g., compound composed of repeated linked units or monomers) including any organic polymers.

The term “diamond nanoparticle” refers to a nanoparticle composed of a diamond mineral or a derivative thereof.

The term “emulsion stabilizing agent” is used herein according to its common ordinary meaning and refers a chemical that increases the ability of an emulsion to resist change in its properties over time (e.g. change from a stable emuslino to un unstable emulsion or seperated liquids).

The term “thickening agent” is used herein according to its common ordinary meaning and refers to a compound increases the viscosity of the liquid.

The term “clay-based thickening agent” is any thickening agent composed of or derived from a clay including, but not limited to, montmorillonite, smectite, sepiolite, attapulgite, bentonite, hectorite, and other organophilic clay.

The term “corrosion resistance” refers to the ability of a metal material to withstand deterioration and/or chemical breakdown that occurs on its surface as the metal reacts to its environment (e.g. corrosion due to exposure to oxygen or water).

The term “hydrophilic polymer” is a polymer containing polar or charged functional groups that is soluble in water.

The terms “polyethylene glycol,” “PEG,” “polyoxyethylene,” and “POE” are used interchangeably and refer to any polymer of ethylene oxide that has the chemical formula C₂ₙH₄ₙ₊₂Oₙ₊₁.

The term “casing” refers to a metal (e.g., steel) pipe that is inserted into the drilled section of a borehole and lines the inside of a wellbore. Typically it is cemented into place.

The term “coil tubing” or “coiled tubing” refers to a metal piping that can be coiled on a spool and through which materials may be transported (e.g., chemicals can be pumped). Coil tubing can be used for fracture stimulation, wellbore cleanout, drilling, well circulation, etc. For instance, it can be used as a conduit for petroleum from the well to flow up from the reservoir. It can be introduced into a wellbore for the placement of fluids or manipulation tools during well intervention procedures.

The term “drill” includes machines used to crush or cut rock useful, for example, in processes to recover petroleum from petroleum wells. Drills may be used in boring holes in natural or synthetic plugs used in hydraulic fracturign processes and forming boreholes to be lined with casing. The term “subterranean drill” refers to a drilling tool that crushes or cuts rocks located under the surface of the earth.

The term “drilling fluid” or “drilling mud” includes any fluid used in the process of drilling for oil or gas reserves. The fluid can be water-based, oil-based, synthetic or gaseous.

The term “petroleum reservoir” refers to a body of earth (e.g., rock) containing petroleum and located underground (e.g., under the surface of the earth or subterranean).

### III. Formulation of the Nanoparticle Lubricity and Anti-Corrosion Agent

The lubricating agent described herein may exhibit liquid friction reduction, mechanical drag reduction and/or metal corrosion inhibition properties, all of which are advantageous for drilling applications. The lubricating properties of the agent are due, at least in part, to the presence of nanoparticles. In one embodiment, the lubricating agent adheres to a metal surface to form a film, thereby reducing or inhibiting corrosion of the metal while simultaneoulsy providing lubrication to reduce friction between the interior of a pipe and material transported within the pipe. Thus, the lubricating agent may substantially or fully coat the interior of a pipe to form a pipe lubricant, a coil tubing lubricant, or in a fracturing fluid, a drilling fluid or a completion fluid.

The lubricating agent may contain a vegetable oil base and other chemicals that are Generally Regarded As Safe materials (GRAS materials). For instance, canola oil which can be used in the emulsion is considered suitable for incidental food contact applications, and the surfactant GMO is used in various food products and skin care products.

The density of the lubricating agent (e.g., emulsion) can be about 0.92 kg/m³ to about 0.980 kg/m³, such as, e.g., about 0.916, 0.920, 0.930, 0.940, 0.950, 0.960, 0.970, or 0.980 kg/m³. The density of the emulsion can be about 0.94 kg/m³ to about 0.960 kg/m³, such as, e.g., about 0.936, 0.940, 0.950, or 0.960 kg/m³. The density of the emulsion can be about 0.98 kg/m³, such as, e.g., about 0.976, 0.977, 0.978, 0.979, 0.980, 0.981, 0.982, 0.983, 0.984, or 0.985 kg/m³.

The specific gravity of the emulsion can be about 6.0 g/l to about 10.0 g/l at 25° C., e.g., about 6.0, 6.5, 6.9, 7.0, 7.5, 7.9, 8.0, 8.5, 8.9, 9.0, 9.5, 9.9, or 10 g/l at 25° C. The specific gravity of the emulsion can be about 7.0 g/l to about 9.0 g/l at 25° C., e.g., about 7.0, 7.5, 7.9, 8.0, 8.5, 8.9, 9.0 g/l at 25° C. The specific gravity of the emulsion can be about 7.9 g/l at 25° C.

The emulsion may include a hydrophilic polymer, a vegetable oil, a plurality of nanoparticles, a surfactant, optionally a fluoropolymer, optionally an emulsion stabilizing agent, and optionally a thickening agent. The emulsion includes a water phase and an oil phase which are mixed together to form a water-in-oil emulsion. Thus, the base emulsion may be produced for suspending and dispersing lubricity additives such as nanoparticles, PTFE, graphite, vermiculite, and other polymers.

The hydrophilic polymer can be a polyalkylene oxide polymer including, but not limited to a polymer of 1 to 500 alkylene oxide units, e.g., 1, 50, 100, 150, 200, 250, 300, 350, 400, 450 or 500 units, or a polymer of 50 to 150 alkylene oxide units, e.g., 50, 60, 70, 80, 90, 100, 110, 120, 130, 140, or 150 units. In some embodiments, the polyalkylene oxide polymer is polyethylene glycol (e.g., polyoxyethylene). In some instance, polyethylene glycol is mixed with water to form the water phase of the emulsion. In some embodiments, polyethylene glycol constitutes 5% of the water phase.

The vegetable oil can be any type of vegetable oil including, but not limited to, canola oil, coconut oil, cottonseed oil, olive oil, palm oil, peanut oil, rapeseed oil, safflower oil, sesame oil, soybean oil, sunflower oil, rice bran oil, corn oil, hemp oil, castor oil, almond oil, arachis oil, maize oil, linseed oil, caraway oil, rosemary oil, peppermint oil, eucalyptus oil, coriander oil, lavender oil, citronella oil, juniper oil, lemon oil, orange oil, clary sage oil, nutmeg oil and tea tree oil. In some embodiments, the vegetable oil is canola oil such as high oleic canola oil. Any oil that is determined to be safe to humans, animals and the environment can be used in the emulsion.

The surfactant of the emulsion can be any type of surfactant including anionic surfactants, cationic surfactants, zwitterionic surfactants and nonionic surfactants. In some embodiments, the surfactant is a nonionic surfactant, such as a nonionic oil soluble surfactant. Non-limiting examples of a nonionic oil soluble surfactant include glycerol mono oleate, sorbital mono oleate, and polyoxyethylene (20) sorbitan monooleate. In some embodiments, the surfactant has a hydrophile lipophile balance (HLB) of about 7 which is useful for water-in-oil emulsions.

In some embodiments, the non-ionic surfactant is selected from the group consisting of glycerol mono oleate, glycerol mono stearate, sorbital mono oleate, diethylene glycol monostearate, propylene glycol mono oleate, sorbitan esters, polysorbates, polyoxyethylene alcohol, alkylphenol ethoxylate, propylene oxide-modified polymethylsiloxane, secondary alcohol ethoxylate, capped alcohol ethoxylate, polyalkoxylated glycol, and polyethoxylated glycol.

The fluoropolymer such as polytetrafluoroethylene or PTFE (e.g., powdered PTFE) acts as a friction reducing agent. Other friction reducing agents that are useful in the emulsion described herein include, but are not limited to, graphite, vermiculite, molybdenum (e.g., molybdenum disulfide) compounds, tungsten carbide, titanium dioxide (TiO₂) nanoparticles, aluminum oxide (Al₂O₃) nanoparticles, iron oxide (Fe₂O₃) nanoparticles, silicon dioxide (SiO₂) nanoparticles, and diamond nanoparticles.

The thickening agent of the emulsion can include, but is not limited to, a clay-based thickening agent such as a clay mineral, mineral thixotrope, organophilic clay additives, other rheological additives, and the like, such as hydrogenated castor oil, modified amines.

The stabilizing agent of the emulsion can be, but is not limited to, a fumed silica emulsion stabilizing agent (e.g., Aerosil 8202, Evonik Industries AG, Hanau-Wolfgang, Germany), a thixotrophic agent, an anti-settling agent, another emulsion stabilizing agent, and the like. The fumed silica is not to be considered a nanoparticle as used herein.

In some embodiments, the emulsion is a water-in-oil emulsion. The water phase can be about 1% to about 50% of the emulsion, e.g., about 1%, 5%, 10%, 15%, 20%, 25%, 30%, 35%, 40%, 45%, or 50% of the emulstion. In some embodiments, the water phase is about 5% to about 40% of the emulsion, e.g., about 5%, 6%, 7%, 8%, 9%, 10%, 11%, 12%, 13%, 14% , 15%, 16%, 17%, 18%, 19%, 20%, 21%, 22%, 23%, 24%, 25%, 26%, 27%, 28%, 29%, 30%, 31%, 32%, 32%, 33%, 34%, 35%, 36%, 37%, 38%, 39% or 40% of the emulsion. Optionally, the water phase is about 8% to about 30% of the emulsion, e.g., about 8%, 9%, 10%, 11%, 12%, 13%, 14% , 15%, 16%, 17%, 18%, 19%, 20%, 21%, 22%, 23%, 24%, 25%, 26%, 27%, 28%, 29%, 30% of the emulsion. The oil phase of the emulsion can be about 50% to about 99% of the emulsion, e.g., about 50%, 55%, 60%, 65%, 70%, 75%, 80%, 85%, 90%, 95%, or 99% of the emulsion. In some embodiments, the oil phase of the emulsion is about 60% to about 95% of the emulsion, e.g., about 60%, 62%, 64%, 66%, 68%, 70%, 72%, 74%, 76%, 78%, 80%, 82%, 84%, 85%, 86%, 88%, 90%, 92%, 94%, 96%, or 98% of the emulsion. Optionally, the oil phase is about 70% to about 92% of the emulsion, e.g., 70%, 71%, 72%, 73%, 74%, 75%, 76%, 77%, 78%, 79%, 80%, 81%, 82%, 83%, 84%, 85%, 86%, 87%, 88%, 89%, 90%, 91%, or 92% of the emulsion. The water phase can be about 8% to about 30% of the emulsion and the oil phase can be about 70% to about 92% of the emulsion. In preferred embodiments, the water phase is about 20% and the oil phase is about 80% of the emulsion, wherein 20% of the emulsion serves as the carrier for the lubricity agent (e.g., nanoparticles).

The water phase can be an emulsifying surfactant such as a high mole alcohol ethoxylate or a polyethylene glycol ester. In some instance, the water phase of the emulsion contains water and polyethylene glycol (PEG). The oil phase of the emulsion can contain canola oil, glycerol mono oleate, a clay-based thickening agent (e.g., mineral thioxtrope), treated fumed silica, polytetrafluoroethylene, and nanoparticles.

### IV. Nanoparticles

The inventors have discovered, inter alia, that the nanoparticle containing lubricating agent described herein can minimize clogging within the drilling system which is a common problem with lubricating agents containing micron-sized beads. The nanobead containing emulsion may provide a greater reduction in friction compared to currently available lubrication products for drilling systems.

The nanoparticles described herein are typically significantly smaller in size compared to industry standards (e.g., 425-850 μm polymer beads and 180-355 μm glass beads). In one exemplary embodiment, the nanoparticles have an average diameter of about 5 nm.

The nanoparticles (e.g., organic or inorganic) of the emulsion can have an average length (i.e., average length of the longest dimension) of about 2 nm to about 200 nm, e.g., 2, 5, 10, 20, 30, 40, 50, 60, 70, 80, 90, 100, 110, 210, 130, 140, 150, 160, 170, 180, 190 or 200 nanometers. The nanoparticles can have an average length of about 2 nm to about 100 nm, e.g., 2, 5, 10, 20, 30, 40, 50, 60, 70, 80, 90 or 100 nanometers. In some instances, the average length is about 2 nm to about 50 nm, e.g., 2, 3, 4, 5, 6, 7, 8, 9, 10, 11, 12, 13, 14, 15, 16, 17, 18, 19, 20, 21, 23, 24, 25, 26, 27, 28, 29, 30, 31, 32, 33, 34, 35, 36, 37, 38, 39, 40, 41, 42, 43, 44, 45, 46, 47, 48, 49, or 50 nanometers.

The nanoparticles (e.g., organic or inorganic) of the emulsion can be less than 100 nm in length. In some embodiments, about 50%, 60%, 70%, 80%, 90%. 95% or 99% of the nanoparticles composed of the same materials have a longest dimension range of ¼ to 4 times or ½ to 2 times the average longest dimension of the nanoparticles. About 50%, 60%, 70%, 80%, 90%. 95% or 99% of the nanoparticles composed of the same materials can have a longest dimension range of ¼ to 4 times the average longest dimension of the nanoparticles. Optionally, about 50%, 60%, 70%, 80%, 90%. 95% or 99% of the nanoparticles composed of the same materials have a longest dimension range of ½ to 2 times the average longest dimension of the nanoparticles. In some embodiments, the about 50%, 60%, 70%, 80%, 90%. 95% or 99% of the nanoparticles composed of the same materials have a longest dimension about ±95%, 90%, 80%, 70%, 50%, 40%, 30%, 20% or 10% the average longest dimension of the nanoparticles. In some embodiments, the about 50%, 60%, 70%, 80%, 90%. 95% or 99% of the nanoparticles composed of the same materials have a longest dimension about ±95%, 90%, 85%, 80%, 75%, 70%, 65%, 60%, 55% or 50% the average longest dimension of the nanoparticles. Optionally, the about 50%, 60%, 70%, 80%, 90%. 95% or 99% of the nanoparticles composed of the same materials have a longest dimension about ±50%, 45%, 40%, 35%, 30%, 25%, 20%, 15% or 10% the average longest dimension of the nanoparticles.

In some embodiments, more than 5% of the nanoparticles are less than 100 nm in length. More than 25% of the nanoparticles can be less than 100 nm in length. More than 50% of the nanoparticles can be less than 100 nm in length. Optionally, more than 75% of the nanoparticles are less than 100 nm in length. In some instances, a plurality of nanoparticles is not comprised of nanoparticles have one uniform size. The plurality of nanoparticles can be substantially monodispersed.

The nanoparticles can be inorganic nanoparticles, organic nanoparticles or a combination thereof

An inorganic nanoparticle can be, but is not limited to, a metal nanoparticle such as a gold nanoparticle, zirconium nanoparticle, silver nanoparticle, platinum nanoparticle, cerium nanoparticle, or arsenic nanoparticle, or a metal oxide nanoparticle such as an iron oxide nanoparticle, aluminum oxide nanoparticle, a titanium oxide nanoparticle, or a silicon oxide nanoparticle. Inorganic nanoparticles can also include, a metal or metaloid carbide, such as tungsten carbide, silicon carbide, boron carbide, and the like, and a metal or metalloid nitride such as titanium nitride, boron nitride, silicon nitride, and the like.

In some embodiments, the inorganic nanoparticles (e.g., TiO₂, Al₂O₃, Fe₂O₃, or SiO₂ nanoparticles) form about less than 10% of the emulsion, e.g., about less than 0.5%, 1.0%, 1.5%, 2.0%, 2.5%, 3.0%, 3.5%, 4.0%, 4.5%, 5.0%, 5.5%, 6.0%, 6.5%, 7.0%, 7.5%, 8.05,8.5%, 9.0%, 9.5%, or 10% of the emulsion. The inorganic nanoparticles can form about less than 5% of the emulsion, e.g., about less than 0.5%, 1.0%, 1.5%, 2.0%, 2.5%, 3.0%, 3.5%, 4.0%, 4.5%, or 5.0% of the emulsion. Optionally, the inorganic nanoparticles form about less than 3% of the emulsion, e.g., about less than 0.5%, 0.6%. 0.7%. 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, or 3% of the emulsion. In some embodiments, the nanoparticles form about 1.0 to about 2.5% of the emulsion, e.g., 1.0% , 1.1%, 1.2%, 1.3%, 1.4%, 1.5%, 1.6%, 1.7%, 1.8%, 1.9%, 2.0%, 2.1%, 2.2%, 2.3%, 2.4%, or 2.5% of the emulsion.

An organic nanoparticle can be, but is not limited to, a polymeric nanoparticle such as a diamond nanoparticle. A diamond nanoparticle can be from a naturally occurring source, such as a by-product of the processing of natural diamonds such as the detonation method, or from a synthetic source, such as prepared by any suitable commercial method.

The organic nanoparticles can be extremely fine-grain nanocrystalline diamond particles of generally similar size and shape. In some embodiments, the diamond nanoparticles have an average length of the longest dimension of about 1 nm to about 100 nm or more, e.g., about 1, 5, 10, 15, 20, 25, 30, 35, 40, 45, 50, 55, 60, 65, 70, 75, 80, 85, 90, 95 or 100 nanometers or more in length. Optionally, the organic nanoparticles can have an average longest dimension of about 1 nm to about of about 10 nm, e.g., 1, 2, 3, 4, 5, 6, 7, 8, 9, or 10 nanometers in length. For instance, the average length of the longest dimension of a specific organic particle can be about 1 nm to about 5 nm, e.g., 1, 2, 3, 4, or 5 nanometers.

Nanoparticles (e.g., inorganic or organic) can have any shape. In some embodiments, the nanoparticles have an approximately round shape, e.g., spherical, elliptical, rounded or curved shape.

### V. Methods of Making

The lubricating agent provided may include a water-in-oil emulsion containing suspended and dispersed lubricant and/or anti-corrosion additives. The oil phase can be made by mixing the vegetable oil, the surfactant, optionally the thickening agent, optionally emulsion stabilizing agent, optionally the fluoropolymer, and the nanoparticles to produce a homogenous oil blend. The water phase can be made by combining water and the hydrophilic polymer. Subsequently, the water phase may be added to the oil phase and slowly blended to produce an emulsion which can be referred to as the “concentrate” or the “base emulsion”. Typically, the water phase and the oil phase are generated separately and then blended together to form an emulsion with dispersed nanoparticles.

The emulsion may be made using standard techniques known in the art for generating water-in-oil emulsion containing suspended particles.

Inorganic nanoparticles can be added to the emulsion to comprise about 0.5% to about 3% (% by weight) of the emulsion, e.g., 0.5%, 0.6%, 0.7%, 0.8%, 0.9%, 1%, 1.1%, 1.3%, 1.5%, 1.7%, 1.9%, 2%, 2.1%, 2.3%, 2.5%, 2.7%, 2.9%, or 3% of the emulsion. In some embodiments, the inorganic particles added to the emulsion to comprise about 1% to about 3% (% by weight) of the emulsion, e.g., 1%, 1.1%, 1.3%, 1.5%, 1.7%, 1.9%, 2%, 2.1%, 2.3%, 2.5%, 2.7%, 2.9%, or 3% of the emulsion.

Organic nanoparticles can be added to the emulsion to comprise about 0.00015% to about 0.002% (% by weight) of the emulsion, e.g., 0.00015%, 0.0002%, 0.0003%, 0.0004%, 0.0005%, 0.0006%, 0.0007%, 0.0008%, 0.0009%, 0.0010%, 0.0011%, 0.0012%, 0.0013%, 0.0014%, 0.0015%, 0.0016%, 0.0017%, 0.0018%, 0.0018%, or 0.002% of the emulsion.

The oil phase can contain about 50% to about 95% (% by weight) high oleic canola oil (e.g., about 50%, 55%, 60%, 65%, 70%, 75%, 80%, 85%, 90% or 95% high oleic canola oil), about 1% to about 5% glycerol mono oleate (e.g., about 1%, 1.5%, 2.0%, 2.5%, 3.0%, 3.5%, 4.0%, 4.5% or 5% of glycerol mono oleate), about 1% to about 2% clay-based thickening agent (e.g., about 1%, 1.1%, 1.2%, 1.3%, 1.4%, 1.5%, 1.6%, 1.7%, 1.8%, 1.9%, 2% clay-based thickening agent), about 1% to about 2% fumed silica emulsion stabilizing agent (e.g., about 1%, 1.1%, 1.2%, 1.3%, 1.4%, 1.5%, 1.6%, 1.7%, 1.8%, 1.9%, 2% fumed silica emulsion stabilizing agent), about 1% to about 5% polytetrafluoroethylene (about 1%, 1.5%, 2.0%, 2.5%, 3.0%, 3.5%, 4.0%, 4.5% or 5% of polytetrafluoroethylene), and about 0.5% to about 3% titanium dioxide nanoparticles (e.g., about 0.5%, 0.6%, 0.7%, 0.8%, 0.9%, 1%, 1.1%, 1.2%, 1.3%, 1.4%, 1.5%, 1.6%,1.7%, 1.8%, 1.9%, 2.0%, 2.1%, 2.2%, 2.3%, 2.4%, 2.5%, 2.6%, 2.7%, 2.8%, 2.9%, 3% titanium dioxide nanoparticles). In some embodiments, the oil phase contains 86.9% (% by weight) high oleic canola oil, 5.0% glycerol mono oleate, 1.9% clay-based thickening agent, 1.3% fumed silica emulsion stabilizing agent, 3.8% polytetrafluoroethylene, and 1.3% titanium dioxide nanoparticles.

The oil phase can contain about 50% to about 95% (% by weight) high oleic canola oil (e.g., about 50%, 55%, 60%, 65%, 70%, 75%, 80%, 85%, 90% or 95% high oleic canola oil), about 1% to about 5% glycerol mono oleate (e.g., about 1%, 1.5%, 2.0%, 2.5%, 3.0%, 3.5%, 4.0%, 4.5% or 5% of glycerol mono oleate), about 1% to about 2% clay-based thickening agent (e.g., about 1%, 1.1%, 1.2%, 1.3%, 1.4%, 1.5%, 1.6%, 1.7%, 1.8%, 1.9%, 2% clay-based thickening agent), about 1% to about 2% fumed silica emulsion stabilizing agent (e.g., about 1%, 1.1%, 1.2%, 1.3%, 1.4%, 1.5%, 1.6%, 1.7%, 1.8%, 1.9%, 2% fumed silica emulsion stabilizing agent), about 1% to about 5% polytetrafluoroethylene (about 1%, 1.5%, 2.0%, 2.5%, 3.0%, 3.5%, 4.0%, 4.5% or 5% of polytetrafluoroethylene), and about 0.0015% to about 0.002% diamond nanoparticles (e.g., 0.00015% to about 0.002% (% by weight), e.g., 0.00015%, 0.0002%, 0.0003%, 0.0004%, 0.0005%, 0.0006%, 0.0007%, 0.0008%, 0.0009%, 0.0010%, 0.0011%, 0.0012%, 0.0013%, 0.0014%, 0.0015%, 0.0016%, 0.0017%, 0.0018%, 0.0018%, or 0.002%).

The water phase can contain about 75% to about 95% (% by weight) water (e.g., 75%, 80%, 85%, 90%, or 95% water) and about 2% to about 10% olyethylene glycol (e.g., 2%, 3%, 45, 5%, 6%,7%, 8%, 9%, or 10% polyethylene glycol). In some embodiments, the water phase contains 95% (% by weight) water and 5.0% polyethylene glycol.

The lubicating agent can be an emulsified blend of about 60% to about 90% of the oil phase (e.g., 60%, 70%, 80%, 90% of the oil phase) and about 40% to about 10% of the water phase (e.g., 40%, 35%, 30%, 25%, 20%, 15%, or 10% of the water phase). In some embodiments, the lubricating agent contains an emulsified blend of 80% oil phase and 20% water phase.

In another exemplary embodiment, the emulsion contains 69.5% (% by weight) high oleic canola oil, 4.0% glycerol mono oleate, 1.5% clay-based thickening agent, 1.0% fumed silica emulsion stabilizing agent, 3.0% polytetrafluoroethylene, 1% polyethylene glycol, 19% water, and 1.0% titanium dioxide nanoparticles.

In another exemplary embodiment, the emulsion contains 69.5% (% by weight) high oleic canola oil, 4.0% glycerol mono oleate, 1.5% clay-based thickening agent, 1.0% fumed silica emulsion stabilizing agent, 3.0% polytetrafluoroethylene, 1% polyethylene glycol, 20% water, and 0.00015%-0.002% diamond nanoparticles.

### VI. Uses

The lubricity and anti-corrosion agents provided herein can be used for reducing friction resulting from inner pipe contact during subterranean drilling for petroleum. The agent can be added to a drilling fluid and applied to form a thick film on the metal surface of the pipe (e.g., casing). The application of the agent reduces friction on metal-to-metal contacts and inhibits metal corrosion of the pipe. Additionally, the nanoparticles in the agent provide lubricity functionality during drilling.

The lubricating agent can be added to any fluid used in drilling applications, such as coil tubing fluid, drilling fluid, drilling mud, completion fluid, and the like. In some embodiments, the lubricating agent is introduced into a subterranean pipe that is in fluid contact with a petroleum reservoir. In other embodiments, the lubricating agent is applied to a subterranean drill.

Advantages of the emulsion provided herein may include, for example: allowing for more weight to be applied to a drill bit attached to coiled tubing; faster dilling processes (e.g. faster drill outs of the drilled material such as metal, earth, rocks, inert material, composite plugs, etc.); increased forces to be applied to coiled tubing; increased forces to be applied to coiled tubing to straighten the coiled tubing for entry into a petroleum well (e.g. increased snub forces); reducing the need to cycle coiled tubing by, for example, partially retracting the coiled tubing out of the well in order to re-drill downwhole materials; allowing for increased coiled tubing lifetime by decreasing coiled tubing corrosion and/or decreasing cycling; decreasing friction induced helical formation of coiled tubing (e.g. sinusoidal configurations with increased frequencies and compressed helical formations); reducing coiled tubing stretching (e.g. reducuction of effective weight of the coiled tubing when retracting out of the well (reduced pick up weights).

In other embodiments, the emulsion increases the overal speed of the petroleum drilling process and reduced that cost per well (e.g. increasing the lifetime of motors used to deliver coiled tubing into a well and retract coiled tubing out of a well). In other embodiments, the anti-corrosion and/or lubircating properties of the emulsion increase the lifetime of the well casing and other metal components of the well bore. In other embodiments, the lubricating agent will cause the or make to cause or reduce pipe drag and buckling.

In some embodiments, the lubricating agent is added to a drilling fluid which is then introduced into coil tubing used for oil well interventions. The lubricating agent can also be used to protect coil tubing from premature failure caused by corrosion. In some embodiments, the lubricating agent lubricates a metal subterranean pipe and/or drill in contact with a petroleum reservoir. In certain instances, the lubricating agent also reduces or inhibits corrosion of the metal of the subterranean pipe or drill.

In some embodiments, the emulsion is added to a drilling fluid such that the emulsion makes up at least about 0.5% of the total drilling fluid. In some embodiments, the emulsion is added to the drilling fluid at a loading level of at least about 0.5%. In other embodiments, the emulsion is added to the drilling fluid such that the treat rate is about 1% to about 3%, e.g., about 1%, 1.5%, 2%, 2.5% or 3%.

The lubricating agent emulsion (e.g., concentrate) can be mixed into any drilling fluid (e.g., drilling mud) by any means recognized in the art, such as, e.g., mixing directly into the mud mixing hopper or suction pit.

### VII. Embodiments

Embodiment 1. An emulsion comprising:(i) a hydrophilic polymer; (ii) a vegetable oil; (iii) a plurality of nanoparticles; and (iv) a surfactant.

Embodiment 2. The emulsion of embodiment 1 having a density of about 0.92 kg/m³ to about 0.970 kg/m³.

Embodiment 3. The emulsion of embodiment 1 having a density of about 0.94 kg/m³ to about 0.960 kg/m³.

Embodiment 4. The emulsion of embodiment 1 having a density of about 0.948 kg/m³.

Embodiment 5. The emulsion of embodiment 1 having a specific gravity of about 6.0 g/l to about 10.0 g/l at 25° C.

Embodiment 6. The emulsion of embodiment 1 having a specific gravity of about 7.0 g/l to about 9.0 g/l at 25° C.

Embodiment 7. The emulsion of embodiment 1 having a specific gravity of about 7.9 g/l at 25° C.

Embodiment 8. The emulsion of embodiment 1, further comprising a fluoropolymer.

Embodiment 9. The emulsion of embodiment 8, wherein said fluoropolymer is polytetrafluoroethylene.

Embodiment 10. The emulsion of one of embodiments 1 to 9, wherein said surfactant is a nonionic surfactant.

Embodiment 11. The emulsion of one of embodiments 1 to 9, wherein said surfactant is a nonionic oil soluble surfactant.

Embodiment 12. The emulsion of one of embodiments 1 to 9, wherein said surfactant is glycerol mono oleate.

Embodiment 13. The emulsion of one of embodiments 1 to 9, wherein said surfactant provides a hydrophilic lipophilic balance (HLB) of approximately 7.

Embodiment 14. The emulsion of one of embodiments 1 to 13, wherein said vegetable oil is canola oil, coconut oil, cottonseed oil, olive oil, palm oil, peanut oil, rapeseed oil, safflower oil, sesame oil, soybean oil, sunflower oil, rice bran oil, corn oil, hemp oil, castor oil, almond oil, arachis oil, maize oil, linseed oil, caraway oil, rosemary oil, peppermint oil, eucalyptus oil, coriander oil, lavender oil, citronella oil, juniper oil, lemon oil, orange oil, clary sage oil, nutmeg oil and tea tree oil.

Embodiment 15. The emulsion of one of embodiments 1 to 13, wherein said vegetable oil is canola oil.

Embodiment 16. The emulsion of one of embodiments 1 to 15, wherein said hydrophilic polymer is a polyalkylene oxide polymer.

Embodiment 17. The emulsion of embodiment 16, wherein said polyalkylene oxide comprises from 1 to 500 alkylene oxide units.

Embodiment 18. The emulsion of embodiment 16, wherein said polyalkylene oxide comprises from 50 to 150 alkylene oxide units.

Embodiment 19. The emulsion of one of embodiments 1 to 18, wherein said hydrophilic polymer is a polyethylene glycol.

Embodiment 20. The emulsion of one of embodiments 1 to 19, wherein said nanoparticles have a density of more than about 2 g/cm³.

Embodiment 21. The emulsion of one of embodiments 1 to 19, wherein said nanoparticles have a density of more than about 2.5 g/cm³.

Embodiment 22. The emulsion of one of embodiments 1 to 19, wherein said nanoparticles have a density of more than about 3 g/cm³.

Embodiment 23. The emulsion of one of embodiments 1 to 22, wherein said nanoparticles are metal nanoparticles.

Embodiment 24. The emulsion of embodiment 23, wherein said metal nanoparticles are gold nanoparticles, zirconium nanoparticles, silver nanoparticles, platinum nanoparticles, cerium nanoparticles, or arsenic nanoparticles.

Embodiment 25. The emulsion of embodiment 23, wherein said metal nanoparticles are metal oxide nanoparticles.

Embodiment 26. The emulsion of embodiment 25, wherein said metal oxide nanoparticles are iron oxide nanoparticles, aluminum oxide nanoparticles, titanium oxide nanoparticles or silicon oxide nanoparticles.

Embodiment 27. The emulsion of one of embodiments 1 to 22, wherein said nanoparticles are polymeric nanoparticles.

Embodiment 28. The emulsion of one of embodiments 1 to 22, wherein said nanoparticles are diamond nanoparticles.

Embodiment 29. The emulsion of one of embodiments 1 to 28, wherein said plurality of nanoparticles are about 2 to about 200 nm in average length.

Embodiment 30. The emulsion of one of embodiments 1 to 28, wherein said plurality of nanoparticles are about 2 to about 100 nm in average length.

Embodiment 31. The emulsion of one of embodiments 1 to 28, wherein said plurality of nanoparticles are about 2 to about 50 nm in average length.

Embodiment 32. The emulsion of one of embodiments 1 to 28, wherein more than 5% of said plurality of nanoparticles are less than 100 nm in length.

Embodiment 33. The emulsion of one of embodiments 1 to 28, wherein more than 25% of said plurality of nanoparticles are less than 100 nm in length.

Embodiment 34. The emulsion of one of embodiments 1 to 28, wherein more than 50% of said plurality of nanoparticles are less than 100 nm in length.

Embodiment 35. The emulsion of one of embodiments 1 to 28, wherein more than 75% of said plurality of nanoparticles are less than 100 nm in length.

Embodiment 36. The emulsion of one of embodiments 1 to 35, further comprising an emulsion stabilizing agent.

Embodiment 37. The emulsion of embodiment 36, wherein said emulsion stabilizing agent is a fumed silica emulsion stabilizing agent.

Embodiment 38. The emulsion of one of embodiments 1 to 37, further comprising a thickening agent.

Embodiment 39. The emulsion of embodiment 38, wherein said thickening agent is a clay-based thickening agent.

Embodiment 40. A subterranean pipe comprising the emulsion of one of embodiments 1 to 39.

Embodiment 41. The subterranean pipe of embodiment 40, wherein said subterranean pipe is in fluid contact with a petroleum reservoir.

Embodiment 42. The subterranean pipe of one of embodiments 40-41, further comprising a petroleum.

Embodiment 43. A subterranean drill comprising the emulsion of one of embodiments 1 to 39.

Embodiment 44. A method of lubricating a metal, the method comprising contacting said metal with the emulsion of one of embodiments 1 to 39.

Embodiment 45. The method of embodiment 44, wherein said emulsion further provides corrosion resistance to said metal.

Embodiment 46. The method of one of embodiments 44-45, wherein said metal forms part of a drill.

Embodiment 47. The method of one of embodiments 44-46, wherein said drill is a subterranean drill.

Embodiment 48. The method of one of embodiments 44-47, wherein said metal forms part of a pipe.

Embodiment 49. The method of one of embodiments 44-48, wherein said pipe is a subterranean pipe.

Embodiment 50. The method of embodiment 49, wherein said subterranean pipe is in fluid contact with a petroleum reservoir.

Embodiment 51. A method of inhibiting corrosion of a metal, said method comprising contacting said metal with the emulsion of one of embodiments 1 to 39.

Embodiment 52. The method of embodiment 51, wherein said metal forms part of a pipe.

Embodiment 53. The method of one of embodiments 51-52, wherein said metal forms part of a subterranean pipe.

Embodiment 54. The method of one of embodiments 51-53, wherein said subterranean pipe is in fluid contact with a petroleum reservoir.

Embodiment 55. The method of one of embodiments 51-54, wherein said metal forms part of a drill.

Embodiment 56. The method of one of embodiments 51-55, wherein said drill is a subterranean drill.

### VIII. Example

The following example is offered to illustrate, but not to limit, the claimed invention.

### Example 1

### Method of Making Nanoparticle Lubricating Agent

This example illustrates a method of making the nanoparticle lubricating agent provided herein. It also shows that the lubricating agent of the invention has a lower coefficient of friction compared to commercially available lubricity agents, as well as increased corrosion resistance.

For a 100 gram (g) of lubricating agent, the oil phase was made first by admixing 70 g of high oleic canola oil (C-104) and 4 g of glycerol mono oleate (GMO). The admixture was blended together at 2,000rpm for 10 minutes. Mixing was stopped such that the powdered products remained in solution. 1 g of clay, 1 g of fumed silica, and 1 g of 3-25 μm range polytetrafluoroethylene (PTFE) were added to the admixture and mixed at 2,000 rpm for 10 minutes.

The water phase was made by mixing 1 g of polyoxyethylene (POE; Ethox MS-100, Ethox Chemicals, Greenville, SC) and 21.998 g of hot water (e.g., at least about 37 ° C. or higher) at 2,000 rpm for 10 minutes to dissolve the POE.

The water phase and the nanoparticles were slowly added to the oil phase and mixed using low shear at 1,000 rpm either continuously over 5 minutes or in progressive stages such that over increments of 5 minutes, 5%, 10%, 20%, 30% and 30% of the water phase and nanoparticle concentrate were added. After the water phase was added to the oil phase, the lubricating agent was further mixed at 1,500 rpm for 5 minutes. The final emulsion contained evenly dispersed PTFE and nanoparticles in suspension.

The friction reducing properties of the nanoparticle emulsions were measured. The emulsion formulation containing diamond nanoparticles had a coefficient of friction (COF) of 0.055-0.06 in a 1% solution in water. The formulation of titanium oxide nanoparticles had a COF of about 0.09 in a 1% solution in water. Both these formulations outperformed currently available lubricating agents which had a COF of 0.11-0.12.

Following NACE TMO 169 test method, using a 750 ml liquid cell, low shear fluid dynamics with a carbon steel C 1018 coupon the rate of corrosion of a control in untreated tap water was 2.74 mpy(millimeter per year), 1% loading of BTL 406 was added the corrosion rate was 0.41 mpy, which equalled an 85% reduction in corrosion.

The performance of the emulsion under extreme pressure was also tested. The formulation bore a load of 100, 150 and 200 pounds and had a film strength of 1346.5 psi, 1760.0 psi and 163.7 psi, respectively.

In summary, the nanoparticle emulsions with evenly dispersed PTFE and nanoparticles in suspension provided effective friction reduction. Thus, the emulsions can be used to provide excellent adhesion to metal surfaces and corrosion inhibition.

Although the foregoing invention has been described in some detail by way of illustration and example for purposes of clarity of understanding, one of skill in the art will appreciate that certain changes and modifications may be practiced within the scope of the appended claims. In addition, each reference provided herein is incorporated by reference in its entirety to the same extent as if each reference was individually incorporated by reference.

What is claimed is:

1. An emulsion comprising:
(i) a hydrophilic polymer;
(ii) a vegetable oil;
(iii) a plurality of nanoparticles; and
(iv) a surfactant.

2. The emulsion of claim 1 having a density of about 0.92 kg/m³ to about 0.970 kg/m³.

3. The emulsion of claim 1, further comprising a fluoropolymer.

4. The emulsion of claim 1, wherein said surfactant is a nonionic surfactant.

5. The emulsion of one claims 1 wherein said vegetable oil is canola oil, coconut oil, cottonseed oil, olive oil, palm oil, peanut oil, rapeseed oil, safflower oil, sesame oil, soybean oil, sunflower oil, rice bran oil, corn oil, hemp oil, castor oil, almond oil, arachis oil, maize oil, linseed oil, caraway oil, rosemary oil, peppermint oil, eucalyptus oil, coriander oil, lavender oil, citronella oil, juniper oil, lemon oil, orange oil, clary sage oil, nutmeg oil and tea tree oil.

6. The emulsion of claim 1, wherein said hydrophilic polymer is a polyalkylene oxide polymer.

7. The emulsion of claim 1, wherein said nanoparticles have a density of more than about 2 g/cm³.

8. The emulsion of claim 1, wherein said nanoparticles are metal nanoparticles.

9. The emulsion of claim 1, wherein said metal nanoparticles are metal oxide nanoparticles.

10. The emulsion of claim 1, wherein said nanoparticle are diamond nanoparticles.

11. The emulsion of claim 1 further comprising an emulsion stabilizing agent.

12. The emulsion of claim 11, wherein said emulsion stabilizing agent is a fumed silica emulsion stabilizing agent.

13. The emulsion of claim 1, further comprising a thickening agent.

14. The emulsion of claim 13, wherein said thickening agent is a clay-based thickening agent.

15. A subterranean pipe comprising the emulsion of claim 1.

16. A subterranean drill comprising the emulsion of claim 1.

17. A method of lubricating a metal, the method comprising contacting said metal with the emulsion of claim 1.

18. A method of inhibiting corrosion of a metal, said method comprising contacting said metal with the emulsion of claim 1.
